(19) United States
(12) Patent Application Publication
(10) Pub. No.: US 2006/0204710 A1
(43) Pub. Date: Sep. 14, 2006

(54) Artificial turf mat and method for manufacturing thereof

(76) Inventor: Hugo De Vries, Ridderkerk (NL)

Correspondence Address: HARNESS, DICKEY & PIERCE, P.L.C., P.O. BOX 8910, RESTON, VA, 20195, US

(21) Appl. No.: 10/539,439

(22) PCT Filed: Dec. 19, 2003
(86) PCT No.: PCT/NL03/00918

§ 371 Date: Apr. 3, 2006

(30) Foreign Application Priority Data
Dec. 19, 2002 (NL) 102214

(51) Int. Cl. B32B 33/00; D05C 17/02; B32B 3/02

(52) U.S. Cl. 428/89; 428/88; 428/87; 428/92

(57) ABSTRACT

The invention relates to an artificial turf mat, comprising a backing and a number of protruding artificial grass blades divided into rows and connected thereto, wherein the mutual distance between successive blades in a row is substantially equal to the distance between adjacent rows and amounts to at least 10 mm. Such an artificial turf mat has uniform properties in all directions. The backing can be a fabric and the blades can be connected to the backing by tufting, wherein at least one support loop protruding less far from the backing can further be formed in each case between successive blades. The invention also relates to an artificial turf field comprising such an artificial turf mat and a layer of loose filling material arranged thereon, the thickness of which is less than the length of the artificial grass blades. The invention further relates to methods for forming the artificial turf mat and the artificial turf field.

The invention relates to an artificial turf mat, comprising a backing and a number of protruding artificial grass blades divided into rows and connected thereto. Such an artificial turf mat is generally known and is used to form artificial turf fields on which for instance sports, and in particular ball sports, are played. The artificial turf fields are herein formed by laying artificial turf mats on a flat, generally slightly resilient ground and then spreading a layer of loose filling material, for instance sand or a mixture of sand and rubber granules, over these artificial turf mats. The layer of filling material herein has a thickness such that the artificial grass blades protrude thereabove, so that the artificial turf field creates the same impression as a natural grass field.

Known artificial turf mats have the drawback however that, as a result of the manner in which they are manufactured, the artificial grass blades in a row stand relatively close to each other, while the mutual distance between the rows is often considerably larger. This has the consequence that an artificial turf field on the basis of such an artificial turf mat will display different properties in different directions. In ball sports this can result in a ball not rolling uniformly over the field. Owing to this irregularity the chance of injury, for instance as a result of performing a sliding tackle, is also relatively great when such a sliding tackle is made in the direction of the rows. Tight packing of the blades in a row has the further result that the filling material is there held fast more firmly than between the rows, whereby local compaction and thereby hardening of the field can occur.

The invention therefore has for its object to provide an artificial turf mat of the above described type wherein these drawbacks do not occur. This is achieved according to the invention in that the mutual distance between successive blades in a row is substantially equal to the distance between adjacent rows and amounts to at least 10 mm.

The distance between the blades and the row spacing preferably amounts to at least 13 mm, and more preferably to at least 16 mm. Owing to such a large gap between the individual blades the filling material can be readily loosened periodically, whereby compression or compaction thereof is avoided. The risk of injury as a result of for instance studs getting caught in the artificial turf mat, or a relatively high rotational resistance thereof, is also reduced by this large interspacing.

The backing and the blades can be formed and mutually connected by weaving. It is however recommended for reasons of production cost that the backing is a fabric and the blades are connected thereto by tufting.

The blades are advantageously formed from a continuous fibre. This greatly simplifies production of the artificial turf mat.

In order in this case to ensure an adequate connection of the blades to the backing despite the relatively large interspacing between the blades, at least one support loop protruding less far from the backing is preferably formed in each case between successive blades. For production engineering purposes it is recommended here that the support loops are formed outside the row of blades. The support loops can even be formed from another fibre material than the blades.

The blades and/or the support loops are preferably formed from a relatively thick and/or heavy fibre material. By making use of a fibre material, for instance a yarn with a high yarn weight (Dtex number) or a large yarn volume, optionally built up from a bundle of different yarns, a well covered mat can be obtained which provides a natural (green) appearance. An additional advantage is that a studded structure can thus be formed on the backing side of the artificial turf mat, particularly when offset support loops, therefore formed outside the row of blades, are applied. This studded structure contributes to the shock absorption and energy restitution by the artificial turf when the artificial turf mat is laid on a flat stable ground such as asphalt, stone chippings or rigid geotextile.

The blades are advantageously formed from monofilament fibre. A filling material to be arranged on the artificial turf mat is hereby less confined than would be the case with the use of fibrillated fibres, whereby compaction of the filling material, and thereby hardening of the artificial turf field, can be prevented.

The invention also relates to an artificial turf field formed by an artificial turf mat as described above and a layer of loose filling material arranged thereon, the thickness of which is less than the length of the artificial grass blades.

The invention further relates to a method for forming an artificial turf mat, comprising of supplying a backing material, supplying an artificial turf material, forming a backing from the backing material, and connecting blades of the artificial turf material divided into rows to the backing. Such a method is also generally known.

The method according to the present invention is distinguished from the known methods in that the blades are connected to the backing such that their mutual spacing in a row is substantially equal to the mutual distance between adjacent rows and amounts to at least 10 mm.

When the backing material is formed into a fabric and the blades are connected to the fabric by tufting, it is recommended that the fabric is guided along a series of reciprocally moving tufting needles placed adjacently of each other at the row distance, and the speed of forward movement of the fabric and the stroke speed of the tufting needles are adjusted to each other such that between successive strokes of the tufting needles the fabric is displaced substantially through the row distance. The desired mutual distance between the blades can thus be ensured in simple manner. This is achieved even more simply when the fabric is stopped after each displacement through the row distance.

Finally, the invention further relates to a method for forming an artificial turf field by arranging on a ground an artificial turf mat as described above and spreading thereover a layer of loose filling material to a thickness which is less than the length of the artificial grass blades.

The invention is now elucidated on the basis of a number of embodiments, wherein reference is made to the annexed drawing, in which:

FIG. 1 shows a schematic perspective view of a part of an artificial turf mat according to a first embodiment of the invention,

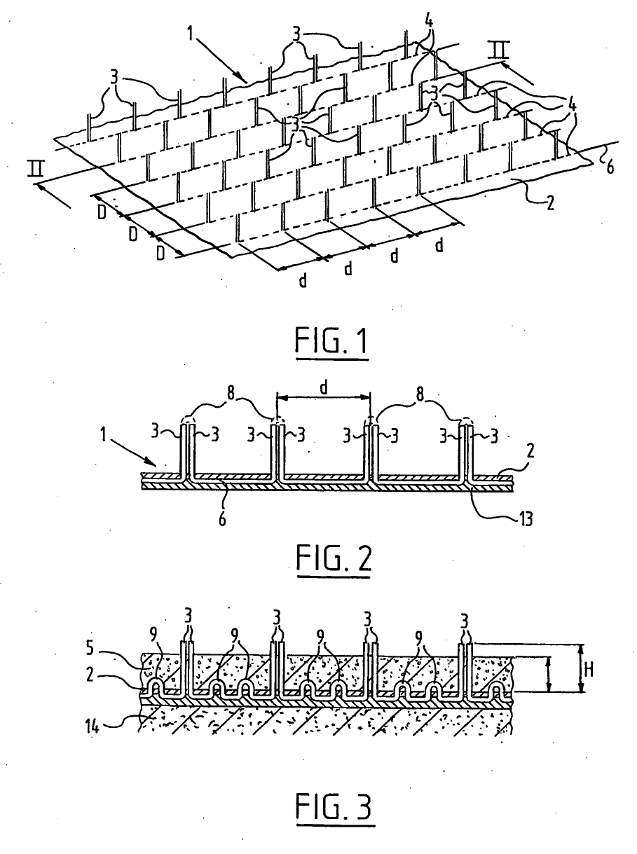

FIG. 2 shows a cross-section along line II-II in FIG. 1,

FIG. 3 is a cross-sectional view corresponding with FIG. 2 of an artificial turf field based on an alternative embodiment of the artificial turf mat,

FIG. 4 is a top view of the artificial turf mat of FIG. 3,

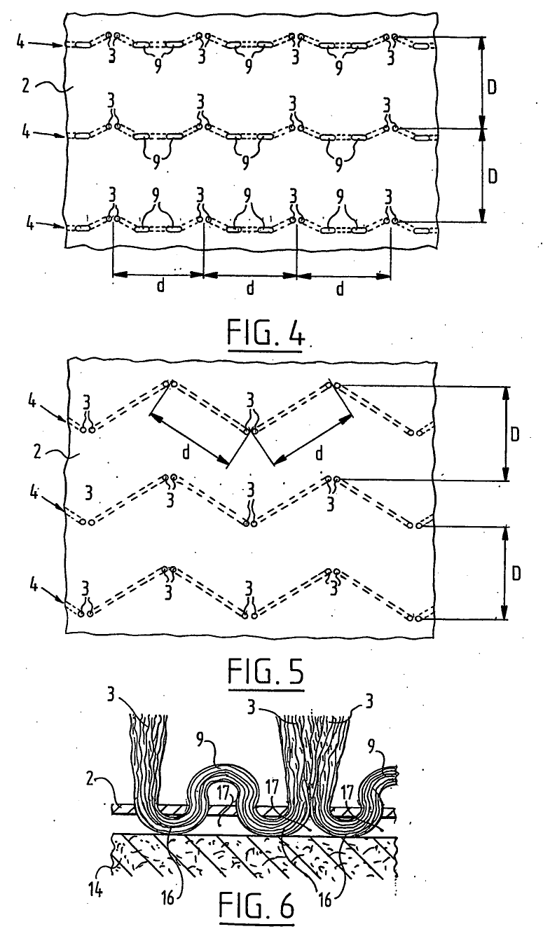

FIG. 5 is a top view of an artificial turf mat with an alternative orientation of the rows of artificial grass blades,

FIG. 6 is a cross-sectional view corresponding with FIG. 2 and 3 of an artificial turf field with yet another embodiment of the artificial turf mat,

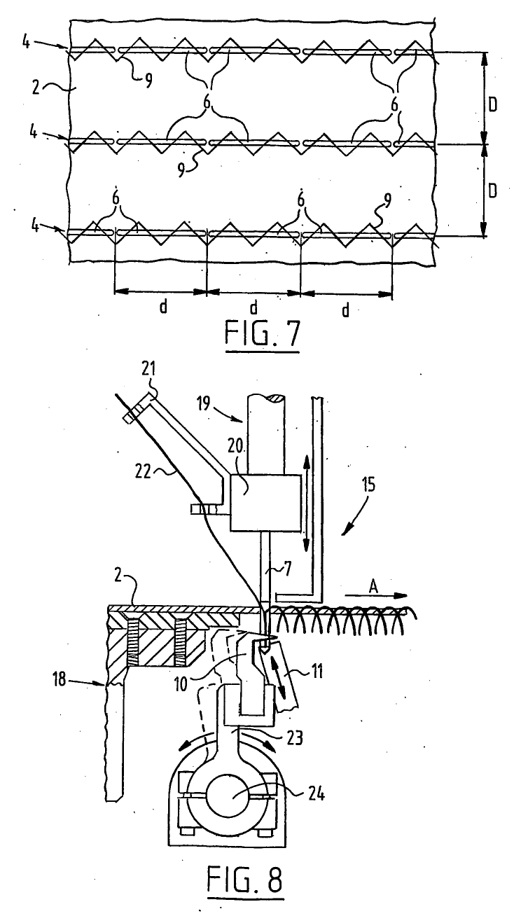

FIG. 7 is a bottom view of an artificial turf mat with separately formed blades and support loops, and

FIG. 8 is a schematic view of a tufting machine with which an artificial turf mat according to the invention can be manufactured.

An artificial turf mat 1 (FIG. 1) comprises a backing 2, for instance in the form of a woven fabric or non-woven, to which is attached a large number of protruding artificial grass blades 3. Blades 3 are distributed uniformly over rows 4 which are likewise uniformly distributed with an interspacing D. The mutual distance between blades 3 in a row 4 is designated with d. According to the present invention these distances are substantially corresponding and it is therefore the case that D≈d. A uniform distribution of the artificial grass blades over mat 1 is hereby obtained, which results in homogeneous properties in all directions of a playing field based on this artificial turf mat 1.

In order to avoid studs of sports footwear catching in the blades 3, and also to prevent a filling material 5 (FIG. 3) spread on artificial turf mat 1 being held too firmly in place, whereby this material would be compacted and hardened, the mutual distances d, D are chosen to be relatively large. According to the invention these two distances amount to 10 mm or more, but more preferably to 13 mm or more, and most preferably to more than 16 mm.

In the shown embodiment the artificial grass blades 3 are tufted into backing 2. Use is herein made for each row 4 of a continuous thread 6, here of monofilament fibre, which is pressed into backing 2 in a regular pattern by an up and downward moving tufting needle 7 (FIG. 8) and then held fast by looping hooks 10, with the formation of loops 8 (FIG. 2). During so-called cut pile tufting these loops 8 are severed or cut by means of knives 11 co-acting with looping hooks 10, whereby two artificial grass blades 3 are formed in each case standing adjacently of each other.

Where mention is made in this text of the mutual distance d between adjacent blades, this does not therefore refer to the distance between blades 3 formed from a single loop 8, but to the distance between two loops 8 and the pairs of blades 3,3 formed therefrom.

In order to strengthen the connection between the continuous tuft thread 6 and backing 2, one or more further support loops 9 can be tufted between successive (pairs of) blades 3. These support loops 9 protrude less far through backing 2 than the loops 8 from which the blades 3 are formed, nor are they cut open. Use can be made to form these support loops of separate or secondary looping hooks, and so as to prevent conflicts between these secondary looping hooks and the looping hooks for forming of blades 3, the support loops 9 are preferably formed outside the row 4 (FIG. 4).

Blades 6 are otherwise fixed in the usual manner in backing 2 after the tufting by providing the latter on the underside with an adhesive layer 13 which can be glued or welded to backing 2.

For application of the invention it is not essential for the rows 4 to run straight. A different pattern, for instance with zigzag rows 4 (FIG. 5), can also be envisaged as long as the mutual distance between the different artificial grass blades (or pairs of blades) 3 is substantially equal, and greater than 10 mm.

For forming of the artificial turf field 12 the artificial turf mat 1 is laid on a flat, slightly resilient ground 14 (FIG. 3) and a layer of loose filling material 5, for instance sand or a mixture of sand and rubber granules, is spread thereover. The thickness h of the layer of filling material 5 is chosen to be smaller than the height H of artificial grass blades 3, so that these latter protrude above filling material 5.

When blades 3 and support loops 9 are formed from a relatively thick fibre material or for instance a composite yarn bundle, the fibre or yarn segments 16 between blades 3 and support loops 9 protrude relatively far on the underside of backing 2, whereby intermediate spaces or air chambers 17 are as it were formed therebetween (FIG. 6). These intermediate spaces 17 contribute toward the shock absorption and energy restitution of artificial turf field 12, which is particularly important when it is laid on a relatively flat and hard ground.

The artificial turf mat 1 as shown here can be manufactured on a tufting machine 15 which is of conventional construction and forms no part of the invention. Tufting machine 15 is provided with a frame with a bed 18 and a head 19 arranged thereabove. Present on the infeed side of bed 18 is a feed roller (not shown here) for the material of backing 2, while on an opposite side there is arranged a wind-up roller (not shown) for the tufted artificial turf mat 1, so that the material of the backing is transported over the bed in the direction of arrow A.

Situated in head 19 is an up and downward movable bar 20 in which is received a series of tufting needles 7. The mutual distance between tufting needles 7 herein defines the row distance D. Guides 21 are further fixed to needle bar 20 for carrying to the needles 7 the fibre material 22 from which the blades 3 are formed.

A number of looping hooks 10 corresponding with the number of tufting needles 7 are arranged in bed 18. These looping hooks 10 are fixed to arms 23 which are pivotable on a shaft 24, so that looping hooks 10 are movable roughly parallel to the backing material and thus roughly transversely of needles 7 to take over the loops placed through the backing material by needles 7. Adjacently of looping hooks 10 are further arranged the knives 11 co-acting therewith which cut open the loops to form said pairs of blades 3.

The wind-up roller, needle bar 20 and pivot shaft 24 are driven by (servo)motors (not shown here) which are all connected to a control system. The insertion depth for instance of needles 7 can hereby be set, while by regulating the motors the insertion speed can be adapted to the winding-up speed such that between two successive insertion movements of needles 7 the material of backing 2 is moved forward each time through the distance d corresponding with the row distance D. In addition, it is possible to interrupt the winding-up each time the tufting needles 7 are inserted into backing 2.

Use could optionally be made for the tufting of a tufting machine with two needle bars movable independently of each other and looping hooks and knives co-acting with the bars, such as described for instance in GB-A-2 357 301. The support loops 9 could hereby be tufted independently of blades 3. For the support loops 9, which could optionally be arranged crosswise over fibre 6 between successive (pairs of) blades 3 (FIG. 7), use could then be made of another fibre material, for instance a much thinner yarn.

Although the invention is elucidated above with reference to an embodiment, it will be apparent that the invention is not limited thereto. The artificial grass blades 3 could thus be connected in a different way to backing 2. Backing 2 could for instance be woven, wherein artificial grass blades 3 could be co-woven at the same time. Materials other than those discussed here are also conceivable. The artificial grass blades 3, or at least the outer ends thereof, could thus be fibrillated. It is also conceivable for the loops 8 not to be cut open, whereby double blades 3 would in fact be formed.

The scope of the invention is therefore defined solely by the now following claims.

1. Artificial turf mat, comprising:
a backing; and
a number of protruding artificial grass blades divided into rows and connected thereto, mutual distance between successive blades in a row being substantially equal to the distance between adjacent rows and amounting to at least 10 mm.

2. Artificial turf mat as claimed in claim 1, wherein the distance between the blades and the row spacing amount to at least 13 mm.

3. Artificial turf mat as claimed in claim 1, wherein the backing and the blades are formed and mutually connected by weaving.

4. Artificial turf mat as claimed in claim 1, wherein the backing is a fabric and the blades are connected thereto by tufting.

5. Artificial turf mat as claimed in claim 4, wherein the blades are formed from a continuous fibre.

6. Artificial turf mat as claimed in claim 5, wherein at least one support loop protruding less far from the backing is formed in each case between successive blades.

7. Artificial turf mat as claimed in claim 6, wherein the support loops are formed outside the row of blades.

8. Artificial turf mat as claimed in claim 7, wherein the support loops are formed from another fibre material than the blades.

9. Artificial turf mat as claimed in claim 6, wherein at least one of the blades and the support loops are formed from a relatively thick or heavy fibre material.

10. Artificial turf mat as claimed in claim 1, wherein the blades are formed from monofilament fibre.

11. Artificial turf field, comprising an artificial turf mat as claimed in claim 1 and a layer of loose filling material arranged thereon, the thickness of which is less than the length of the artificial grass blades.

12. Method for forming an artificial turf mat, comprising:
supplying a backing material,
supplying an artificial turf material,
forming a backing from the backing material, and
connecting blades of the artificial turf material divided into rows to the backing, such that their mutual spacing in a row is substantially equal to the mutual distance between adjacent rows and amounts to at least 10 mm.

13. Method as claimed in claim 12, wherein the blades are connected to the backing at a mutual distance and a row spacing of at least 13.

14. Method as claimed in claim 12, wherein the backing is formed by weaving the backing material, and the artificial turf material is co-woven to form the blades.

15. Method as claimed in claim 12, wherein the backing material is formed into a fabric and the blades are connected to the fabric by tufting.

16. Method as claimed in claim 15, wherein the fabric is guided along a series of reciprocally moveable tufting needles placed adjacently of each other at the row distance, and the speed of forward movement of the fabric and the stroke speed of the tufting needles are adjusted to each other such that between successive strokes of the tufting needles the fabric is displaced substantially through the row distance.

17. Method as claimed in claim 16, wherein the fabric is stopped after each displacement through the row distance.

18. Method as claimed in claim 15, wherein the blades are formed from a continuous fibre.

19. Method as claimed in claim 18, wherein at least one support loop is tufted into a fabric between successive blades, which support loop is pressed less far through the fabric than the adjacent blades.

20. Method as claimed in claim 19, wherein the support loops are formed outside the row of blades.

21. Method as claimed in claim 19, wherein the support loops are formed from another fibre material and connected to the fabric by another set of tufting needles than the blades.

22. Method as claimed in claim 19, wherein at least one of the blades and the support loops are formed from a relatively thick or heavy fibre material.

23. Method as claimed in claim 12, wherein the artificial turf material includes monofilament fibres.

24. Method for forming an artificial turf field by arranging on a ground an artificial turf mat as claimed in claim 1, and spreading thereover a layer of loose filling material to a thickness which is less than the length of the artificial grass blades.
